(19) United States
(12) Patent Application Publication
(10) Pub. No.: US 2025/0232780 A1
(43) Pub. Date: Jul. 17, 2025

(54) ENTITY RESOLUTION USING AUDIO SIGNALS

(71) Applicant: Amazon Technologies, Inc., Seattle, WA (US)

(72) Inventors: Xin He, Melrose, MA (US); Jiyang Wang, Cambridge, MA (US); Xiaozhou Joey Zhou, Dorchester, MA (US); Helian Feng, West Newton, MA (US); Ali Kebarighotbi, Needham, MA (US); Kangrui Ruan, Cambridge, MA (US)

(21) Appl. No.: 18/386,942

(22) Filed: Nov. 3, 2023

(51) Int. Cl. G10L 19/008; G06F 40/295; G10L 15/06; G10L 15/26

(52) U.S. Cl. CPC G10L 19/008; G06F 40/295; G10L 15/063; G10L 15/26

(57) ABSTRACT

Devices and techniques are generally described for audio-based entity resolution. In various examples, first audio data representing speech comprising a mention of a first entity may be received. In some examples, first embedding data representing the first audio data may be received. Second embedding data representing the first entity may be determined. A first modified embedding may be generated using a first attention mechanism to compare the first embedding data to the second embedding data. In some examples, a determination may be made that the first audio data includes a mention of the first entity.

### BACKGROUND

People can interact with computing devices using spoken commands. In some systems, a “wakeword” is used to activate functionality. Natural language processing is used to transform the spoken requests that follow into a computer directive for performing a task.

### BRIEF DESCRIPTION OF DRAWINGS

FIG. 1 is a block diagram illustrating an example system for entity resolution using audio signals, in accordance with various aspects of the present disclosure.

FIG. 2A depicts two example losses that may be used to train the system of FIG. 1, according to various embodiments of the present disclosure.

FIG. 2B depicts embedding clusters generated using three different embedding strategies, in accordance with various aspects of the present disclosure.

FIG. 3 depicts a process for performing entity resolution using an audio signal, in accordance with various aspects of the present disclosure.

FIG. 4 is a block diagram showing an example architecture of a network-connected device that may be used in accordance with various embodiments described herein.

FIG. 5 is a block diagram showing an example architecture of a computing device that may be used in accordance with various embodiments described herein.

FIG. 6 is a block diagram illustrating a natural language processing-enabled device and a natural language processing management system, in accordance with embodiments of the present disclosure.

FIG. 7 depicts an example LLM-based natural language processing flow, in accordance with various aspects of the present disclosure.

### DETAILED DESCRIPTION

In the following description, reference is made to the accompanying drawings that illustrate several examples of the present invention. It is understood that other examples may be utilized and various operational changes may be made without departing from the scope of the present disclosure. The following detailed description is not to be taken in a limiting sense, and the scope of the embodiments of the present invention is defined only by the claims of the issued patent.

Devices with integrated processing capabilities are often configured with network communication capability and/or other computing functions allowing the devices to send data to and/or receive data from other devices. In some examples, such devices may include voice-enabled personal assistants and/or other natural language processing interfaces that may be used to control the devices, answer questions, communicate with other people/devices, and/or otherwise interact with the devices and/or other devices. As such devices become more and more prevalent in both the home, office, public spaces, quasi-public spaces (e.g., hotels, offices, retail spaces), and elsewhere generally, and as the technology matures, new services and features are being developed. For instance, in some cases devices may be paired or otherwise grouped together with one another to enable certain functionality. For example, a device that includes voice-based personal assistant functionality may be paired with a device including a display so that spoken commands may be used to control content output by the display device. In another example, content may be transferred from one device to another device in response to user requests and/or other triggering events (e.g., If This Then That (IFTTT) recipes, presence information, etc.).

Automatic speech recognition (ASR) is a field of computer science, artificial intelligence, and linguistics concerned with transforming audio data associated with speech into data (e.g., text or other machine representation data) representative of the words in the speech. Natural language understanding (NLU) is a field of computer science, artificial intelligence, and linguistics concerned with enabling computers to derive meaning from text input containing natural language, resulting in specific executable commands or other type of instructions. Text-to-speech (TTS) is a field of computer science, artificial intelligence, and linguistics concerned with enabling computers to output synthesized speech. ASR, NLU, and TTS may be used together as part of a speech processing system.

NLU processing may include an intent classification process by which intent data is determined that represents the intent (e.g., goal) of the input natural language data (e.g., text). Intent data may be sent to a skill that may, in turn, perform some action based on the intent data. In some examples, NLU processing may further include named entity recognition (NER), which is a technique used to identify segments of named entities in text data and to categorize the named entities into various predefined classes. Categorization of named entities into such classes is often referred to as “tagging” the named entities. In this context, “NER tags” are metadata that designates a particular class to a named entity. In text, named entities refer to terms that represent real-world objects such as people, places, organizations, locations, etc., which are often denoted by proper nouns.

In some examples, NLU processing may include entity resolution (ER). Entity resolution refers to disambiguation of an entity (e.g., a named entity in text) according to records stored in memory (e.g., in a database). For example, if text includes the proper noun “London,” ER may be used to perform disambiguation to determine whether to link the named entity to a database entry for London in Ontario or a database entry for London in the United Kingdom. In various examples, the NER classes may be used during ER processing to disambiguate between multiple entities.

An ER approach where ASR is first performed (e.g., by an ASR model) to generate a text transcription of input speech, followed by NER tagging, and ER may be referred to as a “cascade” approach. Such an approach can suffer from error propagation, as an error in an upstream task (e.g., an ASR transcription error) can propagate to downstream tasks and result in an incorrect entity being determined for the speech. Accordingly, described herein is a system that may resolve entity information directly from input audio data (e.g., audio representing user speech).

NER and ER processing errors can result in disappointing user experiences. For example, errors that continually misidentify a location name (e.g., where a user requests navigation directions to a particular location), song name, book title, etc., may be frustrating to a user (e.g., a user of a voice interface). An NER and/or ER processing error may result in the user repeating themselves and/or manually selecting the appropriate entity, leading to a frustrating user experience.

One source of ER error is error propagation from an upstream task (e.g., NER errors, ASR errors, etc.). NER errors include span errors, type errors, or both span and type errors. A “span” refers to a grouping of text and/or data representing text (e.g., tokens, sub-tokens, etc.). Below is an example of the input text “when does olive park close” with correct NER processing, NER processing that has resulted in a span error, and NER processing that has resulted in a type error.
Correct: when|Other does|Other olive|RestaurantName park|RestaurantName close|Other
Span Error: when|Other does|Other olive|Other park|RestaurantName close|Other
Type Error: when|Other does|Other olive|PlaceType park|PlaceType close|Other

In the examples above, an NER tag has been added to each token. In the “Correct” example, both “olive” and “park” have been identified as a single span (as both “olive” and “park” are consecutive tokens tagged with the NER tag RestaurantName). In the example, “olive park” may refer to a restaurant called Olive Park. Accordingly, since the tokens olive and park refer to the name of a restaurant, RestaurantName may be the appropriate NER tag for these terms.

In the Span Error example, the token “olive” has been classified with the NER tag “Other,” while “park” has been classified with the NER token “RestaurantName.” Accordingly, since the consecutive tokens olive and park-which pertain to the same entity—have been placed in separate spans (having different NER tags) there is a span error.

In the Type Error example, the tokens “olive” and “garden” have been identified as a single span (as both “olive” and “park” are consecutive tokens tagged with the same NER tag). However, the NER tag may not be correct, as PlaceType may not be the correct classification for the name of the restaurant (e.g., “Olive Park”).

NER processing is prone to such errors in two main contexts. First, depending on the intent and the context of an entity, the same entity string can be tagged differently. In the previous example, the correct annotation has “olive park” tagged as RestaurantName. However, there is another interpretation where “olive” is a city (e.g., Olive, New York) and “park” is a PlaceType, since there may be a park in the city of olive called “Olive Park.” Such ambiguities present a challenge for typical NER/ER processing architectures. Second, rare entities (e.g., entities that are not well represented in the training data used to train machine learned models used by NER/ER processing) are often incorrectly tagged due to a lack of representation during model training.

In many NER/ER processing systems employing a cascade approach, ER processing occurs after NER processing. Accordingly, if there is an error in the classification tags generated by NER processing (or an ASR transcription error), the error may be propagated to ER processing and can lead to an incorrect entity being selected for the natural language input. In various examples described herein, a machine learning architecture is described that is able to accurately perform ER directly from the input audio signal. Advantageously, such a system may avoid error propagation from upstream tasks and may simplify logic (as NER processing may be eliminated in some contexts). Further, as described in further detail below, the systems and techniques described herein may have reduced compute and/or memory requirement relative to previous approaches making such systems and techniques well-suited for edge device deployment. Advantageously, deployment of the ER systems and techniques described herein at the edge may reduce latency and provide an improved user experience relative to natural language processing systems and/or ER systems deployed in the cloud.

Some natural language processing flows may employ one or more large language models (LLMs) in order to process natural language requests. An LLM is an artificial intelligence (AI) model that may be capable of processing and generating human-like text based on the latent information it has learned from vast amounts of training data. The term “large” refers to the size of these models in terms of the number of parameters or weights, which are the values that the model learns during training to make predictions and generate text. LLMs may have millions, billions (or even more) parameters, which enable such models to capture complex patterns and nuances in language that, in turn, allow the models to understand and generate more natural-sounding text (relative to previous approaches). Examples of LLMs include the generative pre-trained transformer models (e.g., GPT-3, GPT-4), Pathways Language Model (PaLM), Large Language Model Meta Artificial Intelligence (LLaMA), and even non-generative examples such as BERT (bidirectional encoder representations from Transformers), etc.

In a generative context, an LLM may generate text that is responsive to the input prompt provided to the LLM. LLMs excel at generating natural sounding text that appears as though it has been generated by a native speaker in the relevant language. In addition to fluency, generative LLMs are able to generate detailed, relevant, and largely accurate responses to input prompts in many cases due to the large amount of latent information the generative LLM has learned during training.

LLMs are typically trained on massive datasets that include a wide variety of text from various sources, enabling the LLMs to understand grammar, context, and the relationships between words and sentences. In various examples described herein, a natural language processing flow may employ an LLM to process a natural language request. In some examples, an LLM-based natural language processing flow may generate a prompt from automatic speech recognition (ASR) output data representing a spoken user utterance. The prompt may be fed into the LLM. In other examples, a text input (e.g., text typed on a keyboard) may be used as an input prompt (or may be used to generate an input prompt) to the LLM. The LLM may be trained to output a text-based action plan which may be a formatted into a series of computer-executable actions (including API calls to various subsystems) that may be taken in order to process the natural language request. In various examples, an LLM-based processing flow may be a recursive process wherein the initial action plan may be executed (e.g., by making various API calls to API providers to receive results/responses), and the responses may be used to generate updated LLM prompts which may then be input into the LLM for generation of an updated action plan. An LLM-based processing flow may not use NLU to determine intent data, and may not route intent and/or slot data (e.g., named entities) to a skill or other natural language processing system. Instead, the action plan generated by the LLM-based processing flow may use a series of function calls to take the necessary actions used to respond to the natural language request. Both LLM-based and non-LLM based natural language processing flows are described in further detail below.

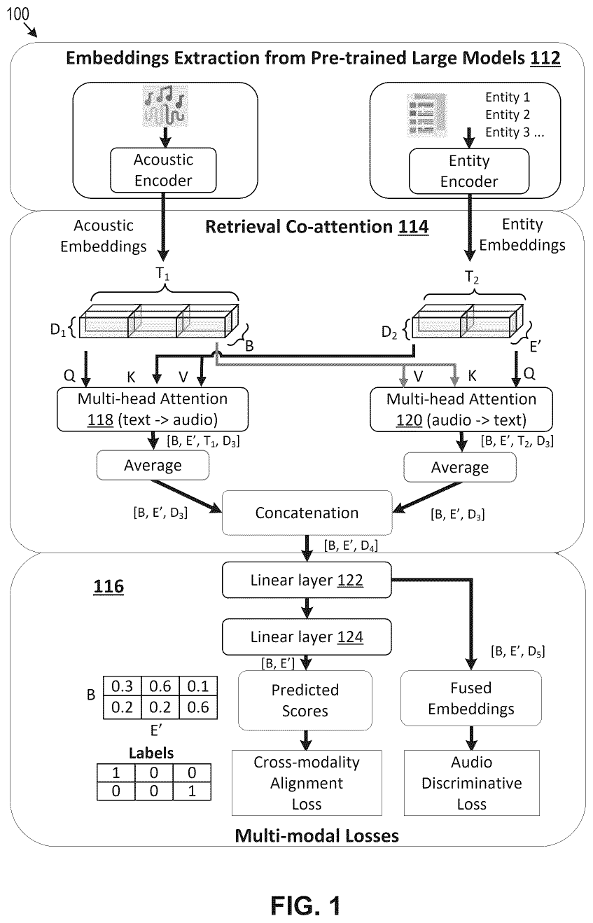

In various examples, the entity resolution system and techniques described herein, which may resolve entities directly from input audio signals, may be used in the context of LLM-based processing flows to improve the generative output of such LLM-based systems. For example, while the system 100 described below in reference to FIG. 1 uses one or more linear layers to generate respective scores for different entities in an entity catalog which may be used to rank the entities that are likely included in the audio, in an LLM-based approach, an ER-specific decoder may be conditioned on the entity catalog data, such that the LLM-generated response directly generates the entity and the conditioning catalog data mitigates risk of entity hallucination. In another example LLM-based implementation, the system 100 may be used to generate a shortlist of entities likely to have been mentioned in the input utterance (e.g., using the top n scoring entities output by the system 100). This shortlist of entities can then be inserted into the prompt data for LLM inference as context. Engineering the prompt to include the shortlist of entities (resolved using the system 100) may improve LLM inference and generate better responses.

Automatic speech recognition (ASR) is a field of computer science, artificial intelligence, and linguistics concerned with transforming audio data associated with speech into text data and/or other ASR output data representative of that speech. In a voice assistant context, such as those described herein, ASR may be used to transform spoken utterances into text that can then serve as the input to an LLM or other language model (e.g., natural language understanding (NLU), which is a field of computer science, artificial intelligence, and linguistics concerned with enabling computers to derive meaning from text input containing natural language, resulting in specific executable command data (e.g., intent data) or other type of instructions). Text-to-speech (TTS) is a field of computer science, artificial intelligence, and linguistics concerned with enabling computers to output synthesized speech. ASR, language models (e.g., natural language generative models such as some LLMs), and TTS may be used together as part of a natural language processing system. As used herein, natural language input data may comprise audio data (e.g., representing a user request or command), text data, and/or other representation data representing natural language for input into a natural language processing system.

The various techniques described herein may be used in a variety of contexts, including in natural language processing enabled devices (e.g., devices employing voice control and/or speech processing “voice assistants”) and/or systems. Examples of speech processing systems and/or voice-enabled personal assistants include the Siri system from Apple Inc. of Cupertino, California, voice-enabled actions invoked by the Bard assistant or the Google Assistant system from Google LLC of Mountain View, California, Dragon speech recognition software or the Copilot system from Microsoft Corporation of Redmond, Washington, the Alexa system from Amazon.com, Inc. of Seattle, Washington, etc. Other examples of smart home devices and/or systems that may use the various content-based voice targeting techniques described herein may include Google Nest Smarthome products from Google LLC, HomeKit devices from Apple Inc., various smart doorbells (e.g., with integrated cameras and/or natural language processing capability), etc. For example, some models of Ring camera-integrated doorbells include Alexa speech processing functionality to allow users to have a virtual assistant interact with people at the door to take messages, etc.

Natural language processing enabled devices may include one or more microphones (e.g., far-field microphone arrays) used to transform audio into electrical signals. Speech processing may then be performed, either locally by the speech processing enabled device, by one or more other computing devices communicating with the speech processing enabled device over a network, or by some combination of the natural language processing enabled device and the one or more other computing devices. In various examples, natural language processing enabled devices may include and/or may be configured in communication with speakers and/or displays effective to output information obtained in response to a user's spoken request or command, and/or to output content that may be of interest to one or more users.

Storage and/or use of data related to a particular person or device (e.g., device identifier data, device names, names of device groups, contextual data, and/or any personal data) may be controlled by a user using privacy controls associated with a speech processing enabled device and/or a companion application associated with a speech processing enabled device. Users may opt out of storage of personal, device state (e.g., a paused playback state, etc.), and/or contextual data and/or may select particular types of personal, device state, and/or contextual data that may be stored while preventing aggregation and storage of other types of personal, device state, and/or contextual data. Additionally, aggregation, storage, and use of personal, device state, and/or contextual information, as described herein, may be compliant with privacy controls, even if not legally subject to them. For example, personal, contextual, device state, and other data described herein may be treated as if it was subject to acts and regulations, such as the Health Insurance Portability and Accountability Act (HIPAA) and the General Data Protection Regulation (GDPR), even if it is not actually subject to these acts and regulations. In various examples, the device and/or device group names and/or any data captured by such devices may be used only in accordance with user permission, in compliance with any relevant laws and/or policies. Additionally, users may opt out of data collection, and/or may opt to delete some or all of the data used by the various techniques described herein, even where deletion or non-collection of various data may result in reduced functionality and/or performance of various aspects of the systems described herein.

In various examples, a natural language processing enabled device may include a wakeword detection component. The wakeword detection component may process audio data captured by microphones of the speech processing enabled device and may determine whether or not a keyword and/or phrase, which are collectively sometimes referred to herein as a “wakeword”, is detected in the audio data. In some examples, when a wakeword is detected, the speech processing enabled device may enter a “sending mode,” “audio capturing mode,” and/or other type of processing mode in which audio detected by the microphones following the wakeword (e.g., data representing user request data spoken after the wakeword) may be sent to natural language processing computing component(s) (either locally or remotely) for further natural language processing (e.g., ASR, NLU, LLM inference, etc.). In various examples, the wakeword detection component may be used to distinguish between audio that is intended for the natural language processing system and audio that is not intended for the natural language processing system.

Machine learning techniques, such as those described herein, are often used to form predictions, solve problems, recognize objects in image data for classification, etc. In various examples, machine learning models may perform better than rule-based systems and may be more adaptable as machine learning models may be improved over time by retraining the models as more and more data becomes available. Accordingly, machine learning techniques are often adaptive to changing conditions. Deep learning algorithms, such as neural networks, are often used to detect patterns in data and/or perform tasks.

Generally, in machine learned models, such as neural networks, parameters control activations in neurons (or nodes) within layers of the machine learned models. The weighted sum of activations of each neuron in a preceding layer may be input to an activation function (e.g., a sigmoid function, a rectified linear units (ReLu) function, etc.). The result determines the activation of a neuron in a subsequent layer. In addition, a bias value can be used to shift the output of the activation function to the left or right on the x-axis and thus may bias a neuron toward activation.

Generally, in machine learning models, such as neural networks, after initialization, annotated training data may be used to generate a cost or “loss” function that describes the difference between expected output of the machine learning model and actual output. The parameters (e.g., weights and/or biases) of the machine learning model may be updated to minimize (or maximize) the cost. For example, the machine learning model may use a gradient descent (or ascent) algorithm to incrementally adjust the weights to cause the most rapid decrease (or increase) to the output of the loss function. The method of updating the parameters of the machine learning model is often referred to as back propagation.

Transformer models are machine learning models that include an encoder network and a decoder network. LLMs are often implemented using transformer models. The encoder takes an input (e.g., a “prompt”) and generates feature representations (e.g., feature vectors, feature maps, etc.) of the input. The feature representation is then fed into a decoder that may generate an output based on the encodings. In natural language processing, transformer models take sequences of words as input. A transformer may receive a sentence and/or a paragraph (or any other quantum of text) comprising a sequence of words as an input.

The encoder network of a transformer comprises a set of encoding layers that processes the input data one layer after another. Each encoder layer generates encodings (referred to herein as “tokens”). These tokens include feature representations (e.g., feature vectors and/or maps) that include information about which parts of the input data are relevant to each other. Each encoder layer passes its token output to the next encoder layer. The decoder network takes the tokens output by the encoder network and processes them using the encoded contextual information to generate an output (e.g., the aforementioned one-dimensional vector of tokens). The output data may be used to perform task-specific functions (e.g., action plan generation for an LLM-based natural language processing flow, etc.). To encode contextual information from other inputs (e.g., combined feature representation), each encoder and decoder layer of a transformer uses an attention mechanism, which for each input, weighs the relevance of every other input and draws information from the other inputs to generate the output (represented by attention scores). Each decoder layer also has an additional attention mechanism which draws information from the outputs of previous decoders, prior to the decoder layer determining information from the encodings. Both the encoder and decoder layers have a feed-forward neural network for additional processing of the outputs, and contain residual connections and layer normalization steps.

### Scaled Dot-Product Attention

The basic building blocks of the transformer are scaled dot-product attention units. When input data is passed into a transformer model, attention weights are calculated between every token simultaneously. The attention unit produces embeddings for every token in context that contain information not only about the token itself, but also a weighted combination of other relevant tokens weighted by the attention weights.

Concretely, for each attention unit the transformer model learns three weight matrices; the query weights W_{Q}, the key weights W_{K}, and the value weights W_{V}. For each token i, the input embedding xᵢ is multiplied with each of the three weight matrices to produce a query vector

qᵢ=XᵢW_{Q},

a key vector

kᵢ=xᵢW_{K},

and a value vector

vᵢ=xᵢW_{V}.

Attention weights are calculated using the query and key vectors: the attention weight aᵢⱼ from token i to token/is the dot product between qᵢ and kⱼ. The attention weights are divided by the square root of the dimension of the key vectors, \sqrt{dₖ}, which stabilizes gradients during training. The attention weights are then passed through a softmax layer that normalizes the weights to sum to 1. The fact that Wo and W_{K} are different matrices allows attention to be non-symmetric: if token i attends to token j, this does not necessarily mean that token j will attend to token i. The output of the attention unit for token i is the weighted sum of the value vectors of all tokens, weighted by aᵢⱼ, the attention from i to each token.

The attention calculation for all tokens can be expressed as one large matrix calculation, which is useful for training due to computational matrix operation optimizations which make matrix operations fast to compute. The matrices Q, K, and V are defined as the matrices where the ith rows are vectors qᵢ, kᵢ, and vᵢ respectively.

$$Attention ( Q , K , V ) = softmax ( \frac{{QK}^{T}}{\sqrt{{d}_{k}}} ) V$$

### Multi-Head Attention

One set of (W_{Q}, W_{K}, W_{V}) matrices is referred to herein as an attention head, and each layer in a transformer model has multiple attention heads. While one attention head attends to the tokens that are relevant to each token, with multiple attention heads the model can learn to do this for different definitions of “relevance.” The relevance encoded by transformers can be interpretable by humans. For example, in the natural language context, there are attention heads that, for every token, attend mostly to the next word, or attention heads that mainly attend from verbs to their direct objects. Since transformer models have multiple attention heads, they have the possibility of capturing many levels and types of relevance relations, from surface-level to semantic. The multiple outputs for the multi-head attention layer are concatenated to pass into the feed-forward neural network layers. In various examples described herein, the ER from audio systems may employ two distinct multi-head attention units, where in one multi-head attention unit the acoustic embedding serves as the query, utilizing the entity embeddings as both the key and value, and in another multi-head attention unit, the entity embeddings are used as the query, and the acoustic embedding become both the key and the value.

Each encoder comprises two major components: a self-attention mechanism and a feed-forward neural network. The self-attention mechanism takes in a set of input encodings from the previous encoder and weighs their relevance to each other to generate a set of output encodings. The feed-forward neural network then further processes each output encoding individually. These output encodings are finally passed to the next encoder as its input, as well as the decoders.

The first encoder takes position information and embeddings of the input data as its input, rather than encodings. The position information is used by the transformer to make use of the order of the input data. In various examples described herein, the position embedding may describe an order of a sequence of words.

Each decoder layer comprises three components: a self-attention mechanism (e.g., scaled dot product attention), an attention mechanism over the encodings, and a feed-forward neural network. The decoder functions in a similar fashion to the encoder, but an additional attention mechanism is inserted which instead draws relevant information from the encodings generated by the encoders. In a self-attention layer, the keys, values and queries come from the same place—in the case of the encoder, the output of the previous layer in the encoder. Each position in the encoder can attend to all positions in the previous layer of the encoder. In “encoder-decoder attention” layers (sometimes referred to as “cross-attention”), the queries come from the previous decoder layer, and the keys and values come from the output of the encoder. This allows every position in the decoder to attend over all positions in the input sequence. The decoder is attending to the encoder features.

FIG. 1 is a block diagram illustrating an example system 100 for entity resolution using audio signals, in accordance with various aspects of the present disclosure. In some examples herein, the system 100 may be referred to as a signal-to-entity (S2E) system (i.e., a system that resolves entity information from input audio signals).

S2E allows ER performance to be directly optimized instead of locally optimizing a series of relevant tasks. Unlike the cascade approach to ER, the system 100 intakes multimodal signals-audio data and textual entity catalog data- and attempts to retrieve the relevant entity mentions in a given audio signal. Unlike traditional ER approaches which are text-based, the system 100 solves a multi-modal retrieval problem. Some other cross-modality approaches, such as contrastive language-image pre-training (CLIP) that aligns an image and text pair, and contrastive language-audio pre-training (CLAP) that aligns a text and audio pair, assume a one-to-one mapping relationship. By contrast, the cross-modality ER approach of system 100, handles multiple-to-one relationships, as multiple audio signals can map to the same entity (e.g., audio of different speakers saying the same entity and/or different spoken sentences that include a mention of the same entity). Additionally, in contrast to traditional cascading approaches, S2E (system 100) offers practical advantages of reducing coordination effort, saving model maintenance cost and being footprint economical. The system 100 reduces the necessity for additional components, such as an ASR transcription decoder and/or a separate NER head, and becomes advantageous in environments with limited compute resources (e.g., edge devices such as local Internet-of-Things devices).

The system 100 enhances modality alignment between audio and entity text signals via an effective retrieval co-attention mechanism and refined training objectives including a modality alignment loss and an audio discriminative loss. The system 100 surpasses the cascaded ER solution, with the system 100 displaying improvements of 2.6%, 47.0%, and 73.3% across three public datasets, while the system 100 is 42% smaller in terms of model parameters.

### Problem Formulation

Given a catalog with a set of entities

ε={e₁,e₂, . . . ,e_{E}}

where E denotes the catalog size and eⱼ denotes a textual entity, let X denote the query audios and M denote the entity mentions in X. The goal of the SZE system 100 is to create a function [symbol] : [symbol] →ε, which maps the entity mention in a given query audio to the correct textual catalog entity label. In various examples, only in-catalog entity mentions may be considered. A separate label may be assigned for queries with no entity mention during evaluation.

The system 100 comprises three modules: multimodal embeddings extraction 112, retrieval co-attention component 114, and multimodal losses 116. For embedding extraction, pre-trained large models may be used (e.g., the Whisper encoder-a pre-trained model that embeds audio signals and/or bidirectional encoder representations from transformers (BERT) for entity catalogs). It should be noted that other encoders may be used to generate encoded representations of the audio signals and/or entity text, as desired. In some examples described herein, the output of the Whisper encoder (or other audio encoder) may be used, and the average of hidden states of the last four layers from BERT may be used. However, different implementations may use different encoded representations of the inputs, as desired.

### Retrieval Co-Attention

One of the challenges for the S2E system 100 is to align the cross-modal audio and text signals. To address this issue, a novel retrieval co-attention mechanism is employed by retrieval co-attention component 114, as shown in FIG. 1. The retrieval co-attention component 114 allows for more effective alignment and fusion of multimodal information. Specifically, the retrieval co-attention component 114 uses two distinct multi-head attention units, where in one multi-head attention unit 118, the acoustic embedding serves as the query and the entity embeddings are used as both the key data and value data. In the other multi-head attention unit 120, the entity embeddings are used as the query, and the acoustic embedding is used as both the key and the value. Algorithm 1 summarizes how a forward pass of a uni-directional retrieval attention is done. With the attention outputs from both directions, the average across the temporal dimension is determined and the two averages may be concatenated, as shown in FIG. 1.

Algorithm 1: PyTorch-style pseudocode for the core implementation
of a forward pass of one of the retrieval co-attention mechanism:

# Embedding 1 shape: [s1, t1, d1]
# Embedding 2 shape: [s2, t2, d2]
# Number of heads: nh
# Head dimension: d
q = q_linear(embeddings1) # query
k = k_linear(embeddings2) # key
v = v_linear(embeddings2) # value
q = q.view(s1,t1,nh,d).permute(0,2,1,3)
k = k.view(s2,t2,nh,d).permute(0,2,1,3)
v = v.view(s2,t2,nh,d).permute(0,2,1,3)
# Calculate attention weights [s1,s2,nh,t1,t2]
qk = torch.einsum(’bntd,enld→bentl’, (q, k))
attn._w = F.softmax(qk / (d**0.5), dim=−1)
# Calculate attention output
attn_out =
torch.einsum(’bentl,enld→bentd’,(attn_w, v))
attn._out = permute(attn._out, dims=(0, 1, 3, 2,
4)).reshape(s1, s2, t1, −1)

The fused embeddings may be derived through a linear projection layer (e.g., linear layer 122) and the corresponding score matrix through another projection layer 124. To obtain each fused embedding, the fused embedding may be extracted across E′ dimension by the matched entity index, where E′ is the size of an entity catalog subset. The entity catalog subset may include the ground truth entity eⱼ (ground truth entity data) and a random sample of negative entities.E′≤E may be adopted to make training more memory efficient.

FIG. 1 depicts predicted score data for two different audio signals in a prediction matrix (e.g., for three different entities in the set of E′). Additionally, ground truth entity labels are shown for the two different audio signals. As shown, an incorrect prediction is made for the top-row audio signal, since the highest predicted score for the top row of the prediction matrix is 0.6 (in the second column), but the ground truth entity label for the audio signal is in the first column. Accordingly, this loss may be used to train the machine learning models of the S2E system 100, as described in greater detail below.

While the implementation of system 100 in FIG. 1 uses an entity scoring/ranking approach, the system 100 may also be used in the context of generative LLM-based speech processing systems. For example, the system 100 described below in reference to FIG. 1 uses one or more linear layers to generate respective scores for different entities in an entity catalog which may be used to rank the entities that are likely included in the audio. In an LLM-based approach, an ER-specific decoder may be conditioned on the entity catalog data, such that the LLM-generated response directly outputs the entity and the conditioning catalog data mitigates risk of entity hallucination. In another example LLM-based implementation, the system 100 may be used to generate a shortlist of entities likely to have been mentioned in the input utterance (e.g., using the top n scoring entities output by the system 100). This shortlist of entities can then be inserted into the prompt data for LLM inference as context. Engineering the prompt to include the shortlist of entities (resolved using the system 100) may improve LLM inference and generate better responses.

The output of the system 100 may be a ranked list of resolved entities enabling a speech processing system to select the highest-ranked entity to perform further processing in accordance with the intent of the user request. For example, if the user utterance is “What is the population of London?” the system 100 may be used to resolve the entity mention “London” to determine if this refers to the city in Ontario or the city in the United Kingdom. Once the entity mention is resolved to one of these two entities, the user question (a request to output the population) may be answered. In another example, the user may request that a particular song be played. However, there may be multiple songs that have the same or similar names. Entity resolution may be used to determine which song to play. In some cases the user may use a shorthand way of referring to a particular entity. For example, a user may say “Turn the volume up on the TV.” The entity mention “TV” may be resolved to multiple different devices within the user's home and the system 100 may resolve the mention to a particular device so that the volume control instruction can be executed.

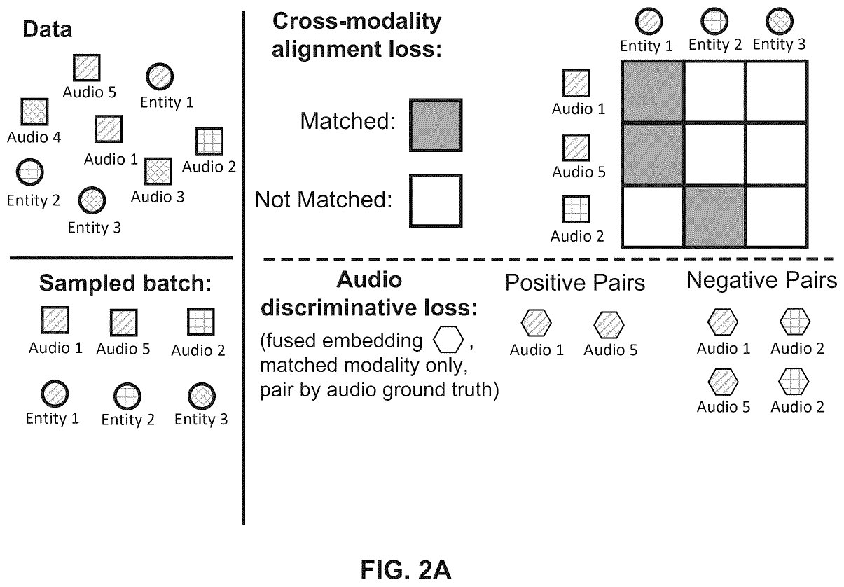

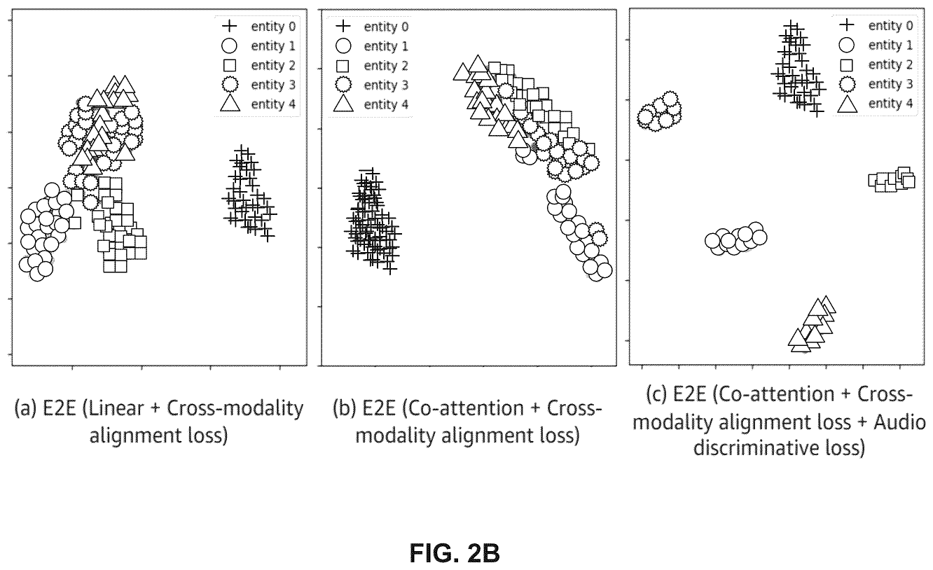

FIG. 2A depicts two example multi-modal losses that may be used to train the system of FIG. 1, according to various embodiments of the present disclosure. FIG. 2A depicts two example training objectives, including a cross-modality alignment loss, [symbol] , and an audio discriminative, loss [symbol] . The cross-modality alignment loss trains the S2E model to identify embeddings that represent aligned cross-modal signals (i.e., audio and ground-truth entity). Additionally, the audio discriminative loss focuses on distinguishing the fused embeddings with entity positive or negative pairs. As the entity-matching from audio signals problem setting follows a many-to-one relationship, the audio discriminative loss enhances the clustering of audios corresponding to the same ground truth entities, thereby improving resolution accuracy. Specifically, the audio discriminative loss pulls two fused embeddings with the same entity index closer, and pushes fused embeddings with different entity indices further away from one another.

For the audio discriminative loss, two example choices are described herein: a triplet loss and n-pair loss. Triplet loss may be defined as:

$$max ( 0 , d ( f , {f}^{+} ) - d ( f , {f}^{-} ) + m ) \qquad ( 1 )$$

where ƒ represents the anchor, ƒ⁺ is the positive example corresponding to ƒ, and ƒ⁻ is the negative example corresponding to ƒ·d denotes the distance function (e.g., L2 distance). The n-pair loss tries to generalize the triplet loss (Eq. (1)) by jointly comparing more than just one negative example. As such, the n-pair loss may offer improved performance relative to triplet loss. The n-pair loss may be defined as:

$$\frac{1}{N} {\sum }_{i} log ( 1 + {\sum }_{j \neq i} exp ( {f}_{i}^{T} {f}_{j}^{+} - {f}_{i}^{T} {f}_{i}^{+} ) ) \qquad ( 2 )$$

where ƒi⁺ is the positive example, and all j≠i are negative examples. Afterwards, the model may be jointly optimized by the total loss below:

$$ℒ = {ℒ}_{cross} + {ℒ}_{A} \qquad ( 3 )$$

where [symbol] is the sum of the cross-modality alignment loss [symbol] and audio discriminative loss [symbol] .

FIG. 2B depicts embedding clusters generated using three different embedding strategies, in accordance with various aspects of the present disclosure. As shown in (a), using linear projection without co-attention or cross modality alignment loss along leads to entangled embedding clusters. Strategy (b) uses co-attention and cross-modality alignment loss without audio discriminative loss. Strategy (b) illustrates some improvement in disentangling the different entity embeddings. However, strategy (c), which uses co-attention, cross-modality alignment loss, and audio discriminative loss exhibits high performance for disentangling the entity embeddings, separating the four clusters of embeddings for different entities.

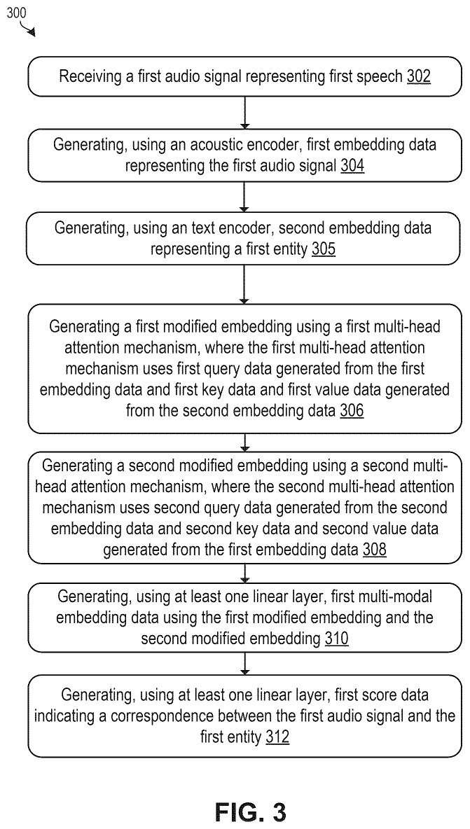

FIG. 3 depicts a process for performing entity resolution using an audio signal, in accordance with various aspects of the present disclosure. The process 300 of FIG. 3 may be executed by one or more computing devices. The actions of process 300 may represent a series of instructions comprising computer-readable machine code executable by a processing unit of a computing device. In various examples, the computer-readable machine code may be comprised of instructions selected from a native instruction set of the computing device and/or an operating system of the computing device. Various actions in process 300 may be described above with reference to elements of FIGS. 1-2. Although shown in a particular order, the steps of process 300 may instead be performed in a different order. Additionally, various steps may be performed in parallel in various implementations. Further, some steps may be omitted and/or other steps may be added in accordance with the entity resolution from audio signal techniques described herein.

Process 300 may begin at action 302, at which a first audio signal representing first speech may be received. The first audio signal may be received, for example, from a voice-assistant enabled device, such as a device comprising one or more far field microphones following wakeword detection.

In some examples, processing may continue at action 304, at which an acoustic encoder may be used to generate first embedding data representing the first audio signal. Any desired acoustic encoder may be used (e.g., Whisper, an acoustic encoder of wav2letter++, Kaldi, etc.). The first embedding data may be a vector or other data structure representing the time series of the input audio signal (e.g., including positional encodings).

Processing may continue at action 305, at which a text encoder may be used to generate second embedding data representing a first entity. Any desired text encoder may be used (e.g., BERT, word2vec, etc.).

Processing may continue at action 306, at which a first modified embedding may be generated using a first multi-head attention mechanism (e.g., a transformer model and/or another machine learning architecture comprising a multi-head attention unit comprising multiple self-attention units). The first multi-head attention mechanism may use the first embedding data as query data and may use the second embedding data as both key and value data.

Processing may continue at action 308, at which second modified embedding may be generated using a second multi-head attention mechanism (e.g., a transformer model and/or another machine learning architecture comprising a multi-head attention unit comprising multiple self-attention units). The second multi-head attention mechanism may use the second embedding data as query data and may use the first embedding data as both key and value data.

Processing may continue at action 310, at which first multi-modal embedding data may be generated by at least one linear layer (e.g., one or more linear layers 122) using the first modified embedding and the second modified embedding. For example, as described above, the first modified embedding and second modified embedding may be averaged across the temporal dimension and concatenated. Processing may continue at action 312, at which the resulting first multi-modal embedding data may be used to predict a score indicating a correspondence between the input audio signal and the first entity. This process may be repeated for each entity across the entity catalog (e.g., respective scores representing a correspondence between the audio signal and each entity embedding).

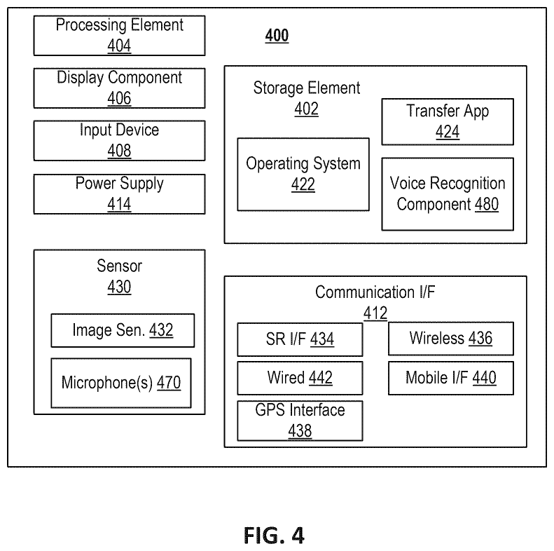

FIG. 4 is a block diagram showing an example architecture 400 of a network-connected device (e.g., a local network-connected device such as a natural language processing-enabled device or another input device) that may be used to implement, at least in part, a voice assistant and/or other speech processing functionality configured to receive spoken and/or other natural input commands, in accordance with various aspects of the present disclosure. It will be appreciated that not all devices will include all of the components of the architecture 400 and some user devices may include additional components not shown in the architecture 400. The architecture 400 may include one or more processing elements 404 for executing instructions and retrieving data stored in a storage element 402. The processing element 404 may comprise at least one processor. Any suitable processor or processors may be used. For example, the processing element 404 may comprise one or more digital signal processors (DSPs). In some examples, the processing element 404 may be effective to determine a wakeword and/or to stream audio data to a speech processing system. The storage element 402 can include one or more different types of memory, data storage, or computer-readable storage media devoted to different purposes within the architecture 400. For example, the storage element 402 may comprise flash memory, random-access memory, disk-based storage, etc. Different portions of the storage element 402, for example, may be used for program instructions for execution by the processing element 404, storage of images or other digital works, and/or a removable storage for transferring data to other devices, etc. In various examples, the storage element 402 may comprise one or more components of the system 100 for entity resolution using audio signals.

The storage element 402 may also store software for execution by the processing element 404. An operating system 422 may provide the user with an interface for operating the computing device and may facilitate communications and commands between applications executing on the architecture 400 and various hardware thereof. A transfer application 424 may be configured to receive images, audio, and/or video from another device (e.g., a mobile device, image capture device, and/or display device) or from an image sensor 432 and/or microphone 470 included in the architecture 400. In some examples, the transfer application 424 may also be configured to send the received voice requests to one or more voice recognition servers.

When implemented in some user devices, the architecture 400 may also comprise a display component 406. The display component 406 may comprise one or more light-emitting diodes (LEDs) or other suitable display lamps. Also, in some examples, the display component 406 may comprise, for example, one or more devices such as cathode ray tubes (CRTs), liquid-crystal display (LCD) screens, gas plasma-based flat panel displays, LCD projectors, raster projectors, infrared projectors or other types of display devices, etc. As described herein, display component 406 may be effective to display content determined provided by a skill executed by the processing element 404 and/or by another computing device.

The architecture 400 may also include one or more input devices 408 operable to receive inputs from a user. The input devices 408 can include, for example, a push button, touch pad, touch screen, wheel, joystick, keyboard, mouse, trackball, keypad, light gun, game controller, or any other such device or element whereby a user can provide inputs to the architecture 400. These input devices 408 may be incorporated into the architecture 400 or operably coupled to the architecture 400 via wired or wireless interface. In some examples, architecture 400 may include a microphone 470 or an array of microphones for capturing sounds, such as voice requests. Voice recognition component 480 may interpret audio signals of sound captured by microphone 470. In some examples, voice recognition component 480 may listen for a “wakeword” to be received by microphone 470. Upon receipt of the wakeword, voice recognition component 480 may stream audio to a voice recognition server for analysis, such as a speech processing system. In various examples, voice recognition component 480 may stream audio to external computing devices via communication interface 412.

When the display component 406 includes a touch-sensitive display, the input devices 408 can include a touch sensor that operates in conjunction with the display component 406 to permit users to interact with the image displayed by the display component 406 using touch inputs (e.g., with a finger or stylus). The architecture 400 may also include a power supply 414, such as a wired alternating current (AC) converter, a rechargeable battery operable to be recharged through conventional plug-in approaches, or through other approaches such as capacitive or inductive charging.

The communication interface 412 may comprise one or more wired or wireless components operable to communicate with one or more other computing devices. For example, the communication interface 412 may comprise a wireless communication module 436 configured to communicate on a network, such as a computer communication network, according to any suitable wireless protocol, such as IEEE 802.11 or another suitable wireless local area network (WLAN) protocol. A short range interface 434 may be configured to communicate using one or more short range wireless protocols such as, for example, near field communications (NFC), Bluetooth, Bluetooth LE, etc. A mobile interface 440 may be configured to communicate utilizing a cellular or other mobile protocol. A Global Positioning System (GPS) interface 438 may be in communication with one or more earth-orbiting satellites or other suitable position-determining systems to identify a position of the architecture 400. A wired communication module 442 may be configured to communicate according to the USB protocol or any other suitable protocol.

The architecture 400 may also include one or more sensors 430 such as, for example, one or more position sensors, image sensors, and/or motion sensors. An image sensor 432 is shown in FIG. 4. An example of an image sensor 432 may be a camera configured to capture color information, image geometry information, and/or ambient light information.

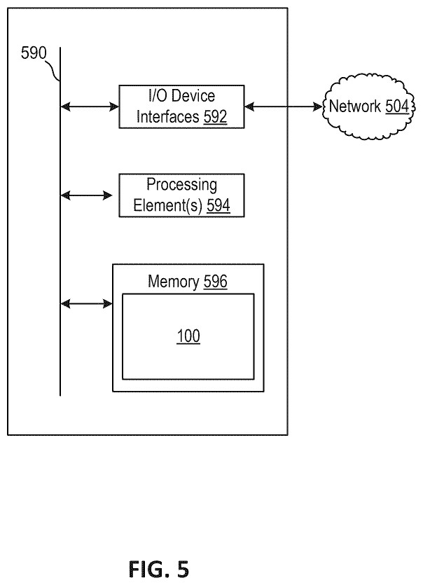

FIG. 5 is a block diagram conceptually illustrating example components of a remote device, such as a computing device executing a particular skill, a computing device executing one or more components of a speech processing system and/or command processing. For example, the various components of FIG. 5 may be used to implement the system 100 for entity resolution using audio signals. Multiple computing devices may be included in the system, such as one speech processing computing device for performing ASR processing, one speech processing computing device for performing NLU processing, one or more skill computing device(s) implementing skills, an LLM-based speech processing system, etc. In operation, each of these devices (or groups of devices) may include non-transitory computer-readable and computer-executable instructions that reside on the respective device, as will be discussed further below. The remote device of FIG. 5 may communicate with one or more other devices over a network 504 (e.g., a wide area network or local area network).

Each computing device of a speech processing system may include one or more controllers/processors 594, which may each include at least one central processing unit (CPU) for processing data and computer-readable instructions, and a memory 596 for storing data and instructions of the respective device. In at least some examples, memory 596 may store, for example, a list of N-best intents data that may be generated for particular request data. In some examples, memory 596 may store machine learning models of the LLM 80, such as machine learned models associated with various multi-head attention modules (described in reference to FIG. 1), when loaded from memory 596. In various further examples, memory 596 may be effective to store instructions effective to program controllers/processors 594 to perform the various techniques described above in reference to FIGS. 1-3. Accordingly, in FIG. 5, the system 100 for entity resolution using audio signals is depicted as being stored within memory 596, as an example. The memories 596 may individually include volatile random access memory (RAM), non-volatile read only memory (ROM), non-volatile magnetoresistive memory (MRAM), and/or other types of memory. Each computing device of a speech processing system (and/or a component thereof) may also include memory 596 for storing data and controller/processor-executable instructions. Each memory 596 may individually include one or more non-volatile storage types such as magnetic storage, optical storage, solid-state storage, etc. Each computing device of a speech processing system may also be connected to removable or external non-volatile memory and/or storage (such as a removable memory card, memory key drive, networked storage, etc.) through respective input/output device interfaces 592. In various examples, the feature data and/or training data used by the various machine learning models may be stored and/or cached in memory 596.

Computer instructions for operating each computing device of a natural language processing system may be executed by the respective device's controllers/processors 594, using the memory 596 as temporary “working” storage at runtime. A device's computer instructions may be stored in a non-transitory manner in non-volatile memory 596 (e.g., a non-transitory computer-readable memory), memory 596, or an external device(s). Alternatively, some or all of the executable instructions may be embedded in hardware or firmware on the respective device in addition to or instead of software.

Each computing device of the various computing devices described herein may include input/output device interfaces 592. A variety of components may be connected through the input/output device interfaces 592, as will be discussed further below. Additionally, each computing device of a speech processing system may include an address/data bus 590 for conveying data among components of the respective device. Each component within a computing device of a speech processing system may also be directly connected to other components in addition to (or instead of) being connected to other components across the bus 590.

As noted above, multiple devices may be employed in a single system. In such a multi-device system, each of the devices may include different components for performing different aspects of the system's processing. The multiple devices may include overlapping components. The components of a speech processing system, as described herein, are exemplary, and may be located as a stand-alone device or may be included, in whole or in part, as a component of a larger device or system.

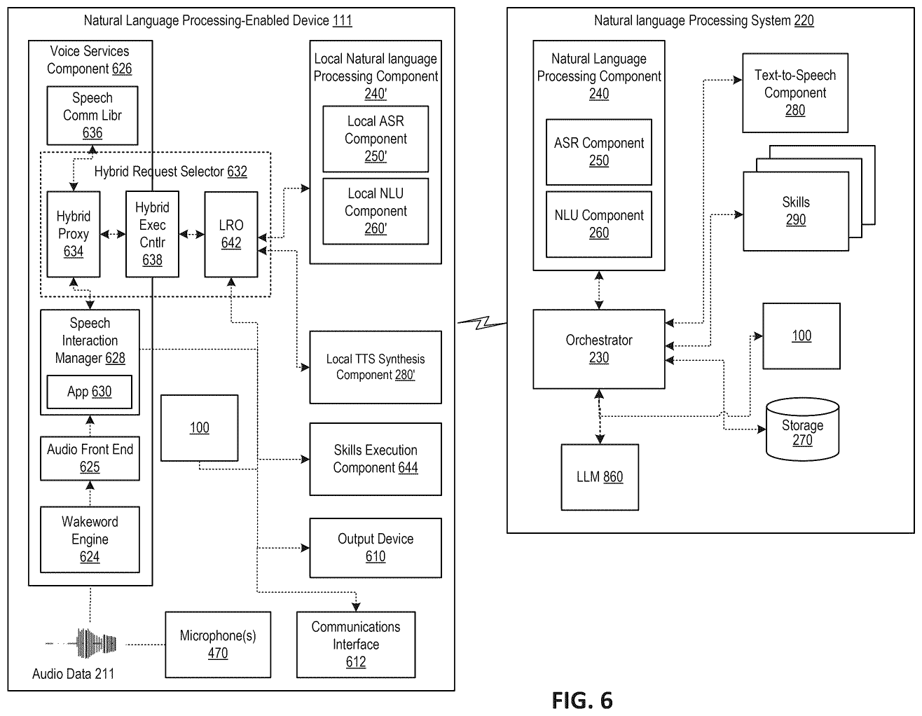

FIG. 6 is a block diagram illustrating a device 111 (e.g., a natural language processing enabled device) and a natural language processing system 220, in accordance with embodiments of the present disclosure. In various examples, device 111 may be a natural language processing-enabled device and may include microphones (e.g., far-field microphone arrays) used to transform audio into electrical signals. The device 111 may be among the network-connected devices described herein that are local to (e.g., communicating on the same LAN) one or more other network-connected devices. Natural language processing may then be performed, either locally by the natural language processing components of device 111 (e.g., an edge device), by one or more other computing devices communicating with the device 111 over a network (e.g., natural language processing system 220), or by some combination of the device 111 and the one or more other computing devices. In various examples, device 111 may include and/or may be configured in communication with output device(s) 610 (e.g., speakers, displays, and/or other network connected devices) effective to output information obtained in response to a user's spoken request or command, or to output content that may be of interest to one or more users. As used herein, a display of the device 111 refers to a display effective to output graphics such as images and/or video. Further, as used herein, a displayless device refers to a device that does not include a display that is effective to render graphical images or text.

In various examples, the device 111 may include and/or may be configured in communication with system 100 for entity resolution using audio signals (S2E). Accordingly, the device 111 may be effective to resolve entity information in input audio signals received via microphone(s) 470. In some examples, deploying the system 100 for entity resolution in a local, edge device may be advantageous as entity resolution may be performed from input audio signals directly without streaming audio data to any backend system, thereby reducing latency and enabling local speech processing. In some examples, the device 111 may include logic to determine whether a particular utterance should be processed locally by the various natural language processing components of the device 111 or should be processed wholly or in part by the backend natural language processing system 220. As previously described, the memory footprint of the system 100 for entity resolution using audio signals is reduced as compared to implementation of an ASR transcription decoder and/or a separate NER head, making the system 100 well-suited for edge deployment while reducing latency.

A natural language processing-enabled computing system may respond to user utterances by outputting content and/or performing one or more other actions, such as playing music, providing information, calling a taxi, displaying an image, etc. Generally, input data received by the various natural language processing systems and components described herein may comprise natural language input data. Natural language input data may be in the form of audio data representing spoken user utterances (e.g., a spoken user request), text data (e.g., a request typed by a user), gesture data (e.g., data representing a user shaking their head while wearing ear buds, making a hand gesture, etc.), and/or some combination of text data, gesture data, and/or audio data.

In some examples, speech-processing systems may be configured with multiple applications (e.g., thousands, tens of thousands, or more applications) that can be used to potentially respond to a user request. Applications may be referred to herein as “skills.” Natural language processing systems may be effective to process spoken and/or textual natural language inputs to determine data representing a semantic understanding of the inputs. Skills may include any application effective to communicate with a natural language processing system in order to take one or more actions based on inputs from the natural language processing system. For example, a speech-processing system may include music skills, video skills, calendar skills, timer skills, general knowledge answering skills, game skills, device control skills, etc. As described herein, skills receive NLU data comprising slot data and/or intent data and are configured to determine one or more actions based on the slot data and/or intent data. Examples of such actions may include text to be processed into output audio data (e.g., synthetic speech) via a text-to-speech (TTS) component, an executable command effective to play a song from a music service, a movie from a movie service, or the like, an executable command effective to cause a system to perform an action (e.g., turning lights on/off, controlling an appliance, purchasing an item, etc.).

The invocation of a skill by a user's utterance may include a request that an action be taken. The number of applications/skills continues to grow and the rate of growth is increasing as developers become more accustomed to application programming interfaces (APIs) and application development kits provided for the voice user interface system. Rule-based approaches and/or predefined utterance matching may be used in some systems for processing requests spoken in a certain format to invoke a particular application. In at least some examples, a “skill,” “skill component,” “skill,” “natural language processing skill,” and the like may be software running on a computing device, similar to a traditional software application running on a computing device. Such skills may include a voice user interface in addition to or instead of, in at least some instances, a graphical user interface, smart home device interface, and/or other type of interface.

In addition to using the microphone(s) 470 to capture utterances and convert them into digital audio data 211, the device 111 may additionally, or alternatively, receive audio data 211 (e.g., via the communications interface 612) from another device in the environment. In various examples, the device 111 may capture video and/or other image data using a camera. Under normal conditions, the device 111 may operate in conjunction with and/or under the control of a remote, network-based or network-accessible natural language processing system 220. The natural language processing system 220 may, in some instances, be part of a network-accessible computing platform that is maintained and accessible via a wide area network (WAN). Network-accessible computing platforms such as this may be referred to using terms such as “on-demand computing”, “software as a service (SaaS)”, “platform computing”, “network-accessible platform”, “cloud services”, “data centers”, and so forth. The natural language processing system 220 may be configured to provide particular functionality to large numbers of local (e.g., in-home, in-car, etc.) devices of different users. The WAN is representative of any type of public or private, wide area network, such as the Internet, which extends beyond the environment of the device 111. Thus, the WAN may represent and/or include, without limitation, data and/or voice networks, a wired infrastructure (e.g., coaxial cable, fiber optic cable, etc.), a wireless infrastructure (e.g., radio frequencies (RF), cellular, satellite, etc.), and/or other connection technologies.

In some embodiments, the natural language processing system 220 may be configured to receive audio data 211 from the device 111, to recognize speech in the received audio data 211, and to perform functions in response to the recognized speech. In some embodiments, these functions involve sending a command, from the natural language processing system 220, to the device 111 to cause the device 111 to perform an action, such as output an audible response to the user speech via output device 610 (e.g., one or more loudspeakers). Thus, under normal conditions, when the device 111 is able to communicate with the natural language processing system 220 over a WAN (e.g., the Internet), some or all of the functions capable of being performed by the natural language processing system 220 may be performed by sending a command over a WAN to the device 111, which, in turn, may process the command for performing actions. For example, the natural language processing system 220, via a remote command that is included in remote response data, may instruct the device 111 to output an audible response (e.g., using a local text-to-speech (TTS) synthesis component 280) to a user's question, to output content (e.g., music) via output device 610 (e.g., one or more loudspeakers) of the device 111, or to control other devices in the local environment (e.g., the user's home). It is to be appreciated that the natural language processing system 220 may be configured to provide other functions, in addition to those discussed herein, such as, without limitation, providing step-by-step directions for navigating from an origin to a destination location, conducting an electronic commerce transaction on behalf of a user as part of a shopping function, establishing a communication session between the current user and another user, etc.

In order to process voice commands locally, the device 111 may include a local voice services component 626. When a user utterance including the wakeword is captured by the microphone 470 of the device 111, the audio data 211 representing the utterance is received by a wakeword engine 624 of the voice services component 626. The wakeword engine 624 may be configured to compare the audio data 211 to stored models used to detect a wakeword (e.g., “Computer”) that indicates to the device 111 that the audio data 211 is to be processed for determining an intent. Thus, the wakeword engine 624 is configured to determine whether a wakeword is detected in the audio data 211, and, if a wakeword is detected, the wakeword engine 624 can proceed with routing the audio data 211 to an audio front end (AFE) 625 (sometimes referred to as an acoustic front end (AFE)) of the voice services component 626. If a wakeword is not detected in the audio data 211, the wakeword engine 624 can refrain from sending the audio data 211 to the AFE 625, thereby preventing the audio data 211 from being further processed. The audio data 211 can be discarded.

The AFE 625 is configured to transform the audio data 211 received from the wakeword engine 624 into data for processing by a suitable ASR component and/or NLU component. The AFE 625 may reduce noise in the audio data 211 and divide the digitized audio data 211 into frames representing a time intervals for which the AFE 625 determines a number of values, called features, representing the qualities of the audio data 211, along with a set of those values, called a feature vector, representing the features/qualities of the audio data 211 within the frame. Many different features may be determined, and each feature represents some quality of the audio data 211 that may be useful for ASR processing and/or NLU processing. A number of approaches may be used by the AFE 625 to process the audio data 211, such as mel-frequency cepstral coefficients (MFCCs), perceptual linear predictive (PLP) techniques, neural network feature vector techniques, linear discriminant analysis, semi-tied covariance matrices, or other approaches known to those of skill in the art. In some embodiments, the AFE 625 is configured to use beamforming data to process the received audio data 211. Beamforming can be used to distinguish between the directions from which speech and noise originate. Accordingly, the microphones 470 may be arranged in a beamforming array to receive multiple audio signals, where multiple audio sources including speech may be identified in different beams and processed. Beamforming may involve processing multiple audio signals (e.g., originating from multiple microphones in a microphone array) together, such as by time shifting one audio signal with respect to another audio signal, to increase the signal and decrease the noise in the audio. Time offsets in the audio data 211, used by the AFE 625 in beamforming, may be determined based on results of the wakeword engine 624's processing of the audio data 211. For example, the wakeword engine 624 may detect the wakeword in the audio data 211 from a first microphone 470 at time, t, while detecting the wakeword in the audio data 211 from a second microphone 470 a millisecond later in time (e.g., time, t+1 millisecond), and so on and so forth, for any suitable number of audio signals corresponding to multiple microphones 470 in a microphone array.

A speech interaction manager (SIM) 628 of the voice services component 626 may receive the audio data 211 that has been processed by the AFE 625. The SIM 628 may manage received audio data 211 by processing request data and non-speech noise or sounds as events, and the SIM 628 may also manage the processing of commands that are used to respond to the user speech or non-speech noise or sounds (e.g., by controlling the action(s) of natural language processing components of device 111). The SIM 628 may include one or more client applications 630 for performing various functions at the device 111.

A hybrid request selector component 632 of the device 111 is shown as including a hybrid proxy component (HP) 634, among other components. The HP 634 can be implemented as a layer within the voice services component 626 that is located between the SIM 628 and a speech communication library (SCL) 636, and may be configured to proxy traffic to/from the natural language processing system 220. For example, the HP 634 may be configured to pass messages between the SIM 628 and the SCL 636 (such as by passing events and instructions there between), and to send messages to/from a hybrid execution controller component (HEC) 638 of the hybrid request selector component 632. For instance, command data received from the natural language processing system 220 can be sent to the HEC 638 using the HP 634, which sits in the path between the SCL 636 and the SIM 628. The HP 634 may also be configured to allow audio data 211 received from the SIM 628 to pass through to the natural language processing system 220 (via the SCL 636) while also receiving (e.g., intercepting) this audio data 211 and sending the received audio data 211 to the HEC 638 (sometimes via an additional SCL).

As will be described in more detail below, the HP 634 and the HEC 638 are configured to perform a handshake procedure to connect to each other. As part of this handshake procedure, the HP 634 and the HEC 638 exchange data including, without limitation, configurations, context, settings, device identifiers (ID), networking protocol versions, time zones, and language data (sometimes referred to herein as “locale data”). Based on at least some of this data (e.g., based at least in part on the language data) exchanged during the handshake procedure, the HEC 638 determines whether to accept or reject the connection request from the HP 634. If the HEC 638 rejects the HP's 634 connection request, the HEC 638 can provide metadata to the HP 634 that provides a reason why the connection request was rejected.

A local natural language processing component 240′ (sometimes referred to as a “natural language processing component,” a “spoken language understanding (SLU) component,” a “speech engine,” or an “engine”) is configured to process audio data 211 (e.g., audio data 211 representing user speech, audio data 211 representing non-speech noise or sounds, etc.). In some embodiments, the hybrid request selector component 632 may further include a local request orchestrator component (LRO) 642. The LRO 642 is configured to notify the local natural language processing component 240′ about the availability of new audio data 211 that represents user speech, and to otherwise initiate the operations of the local natural language processing component 240′ when new audio data 211 becomes available. In general, the hybrid request selector component 632 may control the execution of the local natural language processing component 240′, such as by sending “execute” and “terminate” events/instructions to the local natural language processing component 240′. An “execute” event may instruct the local natural language processing component 240′ to continue any suspended execution based on audio data 211 (e.g., by instructing the local natural language processing component 240′ to execute on a previously-determined intent in order to generate a command). Meanwhile, a “terminate” event may instruct the local natural language processing component 240′ to terminate further execution based on the audio data 211, such as when the device 111 receives command data from the natural language processing system 220 and chooses to use that remotely-generated command data.

The LRO 642 may interact with a skills execution component 644 that is configured to receive intent data output from the local natural language processing component 240′ and to execute a skill based on the intent.

To illustrate how the device 111 can operate at runtime, consider an example where a user utters an expression, such as “Computer, turn off the kitchen lights.” The audio data 211 is received by the wakeword engine 624, which detects the wakeword “Computer,” and forwards the audio data 211 to the SIM 628 via the AFE 625 as a result of detecting the wakeword. The SIM 628 may send the audio data 211 to the HP 634, and the HP 634 may allow the audio data 211 to pass through to the natural language processing system 220 (e.g., via the SCL 636), and the HP 634 may also input the audio data 211 to the local natural language processing component 240′ by routing the audio data 211 through the HEC 638 of the hybrid request selector 632, whereby the LRO 642 notifies the local natural language processing component 240′ of the incoming audio data 211. At this point, the hybrid request selector 632 may wait for response data from the natural language processing system 220 and/or the local natural language processing component 240′.

The local natural language processing component 240′ is configured to receive the audio data 211 from the hybrid request selector 632 as input, to recognize speech (and/or non-speech audio events) in the audio data 211, to determine an intent (e.g., user intent) from the recognized speech (or non-speech audio event). This intent can be provided to the skills execution component 644 via the LRO 642, and the skills execution component 644 can determine how to act on the intent by generating directive data. In some cases, a directive may include a description of the intent (e.g., an intent to turn off {device A}). In some cases, a directive may include (e.g., encode) an identifier of a second device, such as the kitchen lights, and an operation to be performed at the second device. Directive data that is generated by the skills execution component 644 (and/or the natural language processing system 220) may be formatted using Java, such as JavaScript syntax, or JavaScript-based syntax. This may include formatting the directive using JSON. In some embodiments, a locally-generated directive may be serialized, much like how remotely-generated directives are serialized for transmission in data packets over the network. In other embodiments, a locally-generated directive is formatted as a programmatic API call with a same logical operation as a remotely-generated directive. In other words, a locally-generated directive may mimic remotely-generated directives by using a same, or a similar, format as the remotely-generated directive.

The local natural language processing component 240′ may include an automatic speech recognition (ASR) component 250′ that is configured to perform ASR processing on the audio data 211 to convert the audio data 211 into text data (sometimes referred to herein as “ASR text data,” an “ASR result”, or “ASR data”). ASR transcribes audio data 211 into text data representing the words of the user speech contained in the audio data 211. A spoken utterance in the audio data 211 can be input to the local ASR component 250′, which then interprets the utterance based on the similarity between the utterance and pre-established language models available to the local natural language processing component 240′. In some embodiments, the local ASR component 250′ outputs the most likely text recognized in the audio data 211, or multiple hypotheses in the form of a lattice or an N-best list with individual hypotheses corresponding to confidence scores or other scores (such as probability scores, etc.). In some embodiments, the local ASR component 250′ is customized to the user (or multiple users) who created a user account to which the device 111 is registered. For instance, the language models (and other data) used by the local ASR component 250′ may be based on known information (e.g., preferences) of the user, and/or on a history of previous interactions with the user.

The local natural language processing component 240′ may also include a local NLU component 260′ that performs NLU processing on the generated ASR text data to determine intent data and/or slot data (referred to herein as a “NLU result”, or “NLU data”) so that directives may be determined (e.g., by the skills execution component 644) based on the intent data and/or the slot data. Generally, the local NLU component 260′ takes textual input (such as text data generated by the local ASR component 250′) and attempts to make a semantic interpretation of the ASR text data.

### Natural Language Processing System

In other situations, the device 111 may send the audio data 211 to the natural language processing system 220 for processing. As described above, the device 111 may capture audio using the microphone 470, and send audio data 211 (e.g., representing a spoken user request), corresponding to the captured audio, to the natural language processing system 220. The device 111 may include a wakeword detection component that detects when input audio includes a spoken wakeword, and when the wakeword is detected, the audio data 211 is sent by the device 111 to the natural language processing system 220. In the example of FIG. 6, the natural language processing system 220 is an example of a non-LLM-based processing flow 12. However, in other examples, the backend natural language processing system 220 may be implemented as an LLM-based processing flow 14 (such as the LLM-based processing flow described below in reference to FIG. 8).

Upon receipt by the natural language processing system 220, the audio data 211 may be sent to an orchestrator 230. The orchestrator 230 may include memory and logic that enables the orchestrator 230 to send various pieces and forms of data to various components of the system.

Similar to the operation described above with respect to the local natural language processing component 240′ of the device 111, the orchestrator 230 may send the audio data 211 to a natural language processing component 240. An ASR component 250 of the natural language processing component 240 transcribes the audio data 211 into one or more hypotheses representing speech contained in the audio data 211. The natural language processing component 240 interprets the speech in the audio data based on a similarity between the characteristics of the audio data corresponding to the speech and pre-established language models. For example, the natural language processing component 240 may compare the audio data 211 with models for sounds (e.g., subword units such as phonemes) and sequences of sounds to identify words that match the sequence of sounds in the speech represented in the audio data 211. The natural language processing component 240 may send text data generated thereby to an NLU component 260 of the natural language processing component 240. The text data output by the natural language processing component 240 may include a top scoring hypothesis of the speech represented in the audio data 211 or may include an N-best list including a group of hypotheses of the speech represented in the audio data 211, and potentially respective scores ASR processing confidence scores.

The NLU component 260 attempts to make a semantic interpretation of the phrases or statements represented in the text data input therein. That is, the NLU component 260 determines one or more meanings associated with the phrases or statements represented in the text data based on individual words represented in the text data. The NLU component 260 interprets a text string to derive an intent of the user (e.g., an action that the user desires be performed) as well as pertinent pieces of information in the text data that allow a device (e.g., the natural language processing system 220) to complete the intent. For example, if the text data corresponds to “Play the new album by {Musical_Artist}”, the NLU component 260 may determine the user intended to invoke a music playback intent to play the identified album.

The natural language processing system 220 may include a non-transitory computer-readable memory storage 270, storing various instructions for operation of the natural language processing system 220. As previously described, in some examples, the system 100 for entity resolution using audio signals (S2E) may be instantiated as a part of the natural language processing system 220 and/or as a separate component configured in communication with the natural language processing system 220.

As described above, the natural language processing system 220 may include one or more skills 290. The natural language processing system 220 may also include a TTS component 280 that synthesizes speech (e.g., generates audio data) corresponding to text data input therein. The TTS component 280 may perform speech synthesis using one or more different methods. In one method of synthesis called unit selection, the TTS component 280 matches text data against one or more databases of recorded speech. Matching units are selected and concatenated together to form audio data. In another method of synthesis called parametric synthesis, the TTS component 280 varies parameters such as frequency, volume, and noise to create an artificial speech waveform output. Parametric synthesis uses a computerized voice generator, sometimes called a vocoder.

The various components of the natural language processing system 220 and the device 111 described herein may be implemented in software, hardware, firmware, or some combination thereof.

The natural language processing system 220 may reside on device 111, in a cloud computing environment, or some combination thereof. For example, the device 111 may include computing equipment, some portion of which is configured with some or all of the components or functionality of natural language processing system 220 and another portion of which is configured with some or all of the components or functionality of computing device(s) used in natural language processing system 220. The device 111 may then perform a variety of functions on its own (such as when remote communications are unavailable), and/or may communicate (when capable) with computing device(s) and/or the natural language processing system 220 to perform other functions. Alternatively, all of the functionality may reside on the device 111 or remotely.

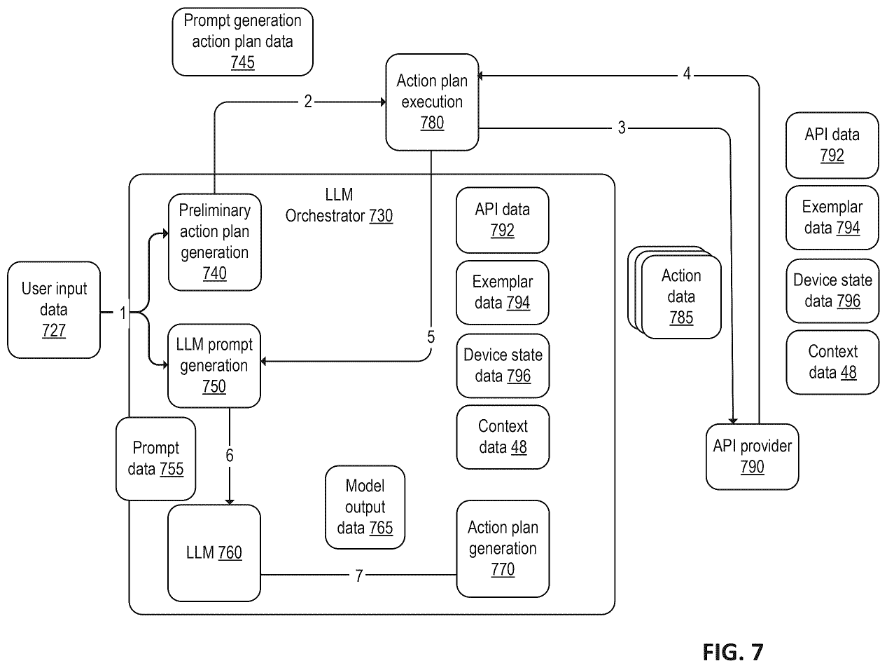

FIG. 7 depicts an example LLM-based natural language processing flow (which may be an example LLM architecture (e.g., of LLM 80 described above), in accordance with various aspects of the present disclosure. In various examples, the system 100 for entity resolution using audio signals may be used to resolve entities that may then be provided to the LLM architecture of FIG. 7 as part of the prompt (e.g., as context data). The example architecture in FIG. 7 includes an LLM orchestrator 730 and various other components for determining an action responsive to a user input. The architecture may further include an action plan execution component 780 and an API provider component 790. With reference to FIG. 7, the LLM orchestrator 730 may include a preliminary action plan generation component 740, a LLM prompt generation component 750, an LLM 760, and an action plan generation component 770. In various examples, the LLM 760 may be a generative model.

In some examples, the LLM 760 may be a transformer-based seq2seq model involving an encoder-decoder architecture. In some such embodiments, the LLM 760 may be a multilingual (approximately) 20 billion parameter seq2seq model that is pre-trained on a combination of denoising and Causal Language Model (CLM) tasks in various languages (e.g., English, French, German, Arabic, Hindi, Italian, Japanese, Spanish, etc.), and the LLM 760 may be pre-trained with approximately 1 trillion tokens. Being trained on CLM tasks, the LLM 760 may be capable of in-context learning. An example of such a LLM is Alexa Teacher Model (Alexa™).

In various examples, the input to the LLM 760 may be in the form of a prompt. A prompt may be a natural language input, for example, an instruction, for the LLM 760 to generate an output according to the prompt. The output generated by the LLM 760 may be a natural language output responsive to the prompt. The prompt and the output may be text in a particular spoken language. For example, for an example prompt “how do I cook beans?”, the LLM 760 may output a recipe (e.g., a step-by-step process) to cook beans. As another example, for an example prompt “I am hungry. What restaurants in the area are open?”, the LLM may output a list of restaurants near the user that are open at the current time.

The LLM 760 may be configured using various learning techniques. For example, in some embodiments, the LLM 760 may be configured (e.g., “fine tuned”) using few-shot learning. In few-shot learning, the model learns how to learn to solve the given problem. In this approach, the model is provided with a limited number of examples (i.e., “few shots”) from the new task, and the model uses this information to adapt and perform well on that task. Few-shot learning may require fewer amount of training data than implementing other fine-tuning techniques. For further example, in some embodiments, the LLM 760 may be configured using one-shot learning, which is similar to few-shot learning, except the model is provided with a single example. As another example, in some embodiments, the LLM 760 may be configured using zero-shot learning. In zero-shot learning, the model solves the given problem without examples of how to solve the specific/similar problem and just based on the model's training dataset. In this approach, the model is provided with data sampled from a class not observed during training, and the model learns to classify the data.

The LLM orchestrator 730 may be configured for generating the prompt to be used by the LLM 760 to determine an action responsive to a user input. As shown in FIG. 7, the LLM orchestrator 730 receives (at step 1) user input data 727. In some instances, the user input data 727 may correspond to a text or tokenized representation of a user input. For example, prior to the LLM orchestrator 730 receiving the user input data 727, another component (e.g., an ASR component) may receive audio data representing the user input. The ASR component may perform ASR processing on the audio data to determine ASR output data corresponding to the user input. As previously described, the ASR component may determine ASR data that includes an ASR N-best list including multiple ASR hypotheses and corresponding confidence scores representing what the user may have said. The ASR hypotheses may include text data, token data, etc. as representing the input utterance. The confidence score of each ASR hypothesis may indicate the ASR component's level of confidence that the corresponding hypothesis represents what the user said. The ASR component may also determine token scores corresponding to each token/word of the ASR hypothesis, where the token score indicates the ASR component's level of confidence that the respective token/word was spoken by the user. The token scores may be identified as an entity score when the corresponding token relates to an entity. In some instances, the user input data 727 may include a top scoring ASR hypothesis of the ASR data. In addition, entity data recognized using the system 100 may be provided as part of the input data 727.

As illustrated in FIG. 7, the user input data 727 may be received at the preliminary action plan generation component 740 and the LLM prompt generation component 750 of the LLM orchestrator 730. The preliminary action plan generation component 740 processes the user input data 727 to generate prompt generation action plan data 745 corresponding to an instruction(s) (e.g., a request(s)) for one or more portions of data usable to generate a language model prompt for determining an action responsive to the user input). In some examples, the one or more portions of data may be data that is determined to be relevant for processing of the user input. The one or more portions of data may represent one or more actions (e.g., API definitions), one or more exemplars corresponding to the actions (e.g., example model outputs including an appropriate use of the API), one or more device states corresponding to one or more devices associated with the user input, and/or one or more other contexts associated with the user input. For example, if the user input data 727 represents a user input of “please turn on the kitchen lights every morning at 7 am,” then the preliminary action plan generation component 740 may determine prompt generation action plan data 745 representing instructions for one or more actions (e.g., API definitions) related to turning on the kitchens lights every morning, one or more exemplars corresponding to the related actions, one or more device states corresponding to one or more devices associated with the “kitchen lights”, and one or more other contexts. For further example, if the user input data 727 represents a user input of “What is the elevation of Mt. Everest,” then the preliminary action plan generation component 740 may determine prompt generation action plan data 745 representing instructions for one or more actions (e.g., API definitions, specifications, schemas) related to the user input and one or more exemplars corresponding to the related actions, as other information, such as devices states or other contextual information (user profile information, device profile information, weather, time of day, historical interaction history) may not be relevant.

In some examples, the prompt generation action plan data 745 may include one or more executable API calls usable for retrieving the one or more portions of data from the corresponding component. For example, instructions included in the prompt generation action plan data 745 may include “FETCH_API,” “FETCH_EXEMPLAR,”

“FETCH DEVICE STATE,” “FETCH_CONTEXT,” etc., along with optional API arguments/inputs. In some embodiments, the prompt generation action plan data 745 may also include the user input data 727. The prompt generation action plan data 745 may be sent (at step 2) to the action plan execution component 780.

In some examples, the preliminary action plan generation component 740 may be configured to process the user input data 727 to determine a representation of the user's request. In various examples, the representation of the user's request may be a reformulation of the user's request. For example, the if the user input data 727 represents a user input of “I have always wanted to travel to Japan, I have heard it's beautiful. How tall is Mt. Fuji?”, then the preliminary action plan generation component 740 may determine the representation of the user's request as being “How tall is Mt. Fuji,” or the like. The preliminary action plan generation component 740 may generate the prompt generation action plan data 745 using the determined representation of the user's request.

In some examples, the preliminary action plan generation component 740 may implement one or more machine learning (ML) models. A first ML model(s) may be configured to take as input the user input data 727 and generate a representation of the user's request. For example, the ML model may be a text summarization model or a text rewrite model. A second ML model (or the first ML model) may be configured to take as input the representation of the user's request (or the user input data 727) and determine the one or more portions of data relevant for processing of the user input. For example, the second ML model may be a classifier trained to classify the user's request (or the user input data 727) to determine data (or types of data) relevant to the processing of the user input (e.g., one or more related actions (e.g., API definitions), one or more exemplars corresponding to the one or more related actions, one or more device states corresponding to one or more related devices, one or more related contexts, etc.)

In other embodiments, the preliminary action plan generation component 740 may be an LLM, similar to the LLM 760. In such embodiments, the architecture (e.g., LLM 80) may include a further component configured to generate a prompt to be provided to the LLM (e.g., similar to the LLM prompt generation component 750) or the prompt may be generated by the LLM prompt generation component 750. The component may generate a prompt (e.g., according to a template) including the user input data 727 and instructions to determine the one or more portions of data (or types of data) relevant to the processing of the user input. The LLM may process the prompt and generate model output data representing the one or more portions of data (or types of data). The preliminary action plan generation component 740 may process the model output data to determine the prompt generation action plan data 745.

The action plan execution component 780 may process the prompt generation action plan data 745 to execute the one or more instructions to retrieve/receive data corresponding to the user input and that may be used to generate the language model prompt. As described above, in some examples, the system 100 may be used to generate a shortlist of entities likely to have been mentioned in the input utterance (e.g., using the top n scoring entities output by the system 100). This shortlist of entities can then be inserted into the prompt for LLM inference as context. Engineering the prompt to include the shortlist of entities (resolved using the system 100) may improve LLM inference and generate better responses. As shown in FIG. 7, the action plan execution component 780 processes the prompt generation action plan data 745 to generate action data 785 representing an action included in the prompt generation action plan data 745 (e.g., a single instruction, such as FETCH_CONTEXT). For example, in the situation where the action is represented by an API call, the action data 785 may represent the action plan execution component 780 executing the API call included in the prompt generation action plan data 745. The action data 785 may be sent (at step 3) to the API provider component 790. In the situation where the prompt generation action plan data 745 includes more than one instruction, the action plan execution component 780 may generate more than one instance of action data 785 (e.g., one instance for each instruction included in the prompt generation action plan data 745) and send each instance to the API provider component 790.

The API provider component 790 may process the (one or more instances of the) action data 785 and cause the retrieval of the (one or more portions of) data associated with the action data 785. The API provider component 790 may include a knowledge provider component. The knowledge provider component may include an API retrieval component, an exemplar retrieval component, a device state retrieval component, and an “other” context retrieval component. The knowledge provider component may provide the action data 785 to the component(s) configured to determine the data corresponding to the request(s) represented by the action data 785.

For example, the API retrieval component (not shown) may process the action data 785 to generate API data 792 representing one or more APIs that correspond to an action performable with respect to the user input. For example, if the user input corresponds to “turn on the kitchen light,” the API retrieval component may determine an API usable to control a device and include an API definition corresponding to the API in the API data 792. In some embodiments, the API definition may include one or more API call frameworks for instructing/requesting that the API perform an action (e.g., turn_on_device (device: [device name]), turn_off_device (device: [device name]), set_device_temperature (device: [device name]); temperature: [temperature], set_device_volume (device: [device name]; volume: [volume value]), etc.). In some embodiments, the API definition may include a natural language description of the functionality of the API (e.g., a natural language description of the actions performable by the API/API call framework). For example, for the abovementioned API determined to be associated with the user input of “turn on the kitchen light,” the API definition may further include a natural language description of “used to power on a device.” In some embodiments, the one or more API definitions may be included in the API data 792 based on them being semantically similar to the user input. For example, the API retrieval component may be capable of comparing (e.g., using cosine similarity) (an encoded representation of) the user input to (an encoded representation of) the API definition to determine a semantic similarity between the user input and the API definition (e.g., a semantic similarity between the user input and the natural language description of the functionality of the API included in the API definition). If the API definition is determined to be semantically similar to the user input, then the corresponding API definition may be included in the API data 792. In some embodiments, the API retrieval component may include the top-n identified API definitions in the API data 792. The API data 792 may be sent (at step 4) to the action plan execution component 780 as shown in FIG. 7.

For further example, the exemplar retrieval component may process the action data 785 to generate exemplar data 794 representing one or more exemplars associated with one or more APIs (e.g., the API represented by the API data 792). As used herein, an “exemplar” associated with an API corresponds to an example use of the API (e.g., an example language model output including use of the API (e.g., via a corresponding API call) with respect to a user input, where the user input is similar to the current user input. For example, for an API associated with the API call framework “turn_on_device (device: [device name]),” and the current user input “please turn on the kitchen lights” the exemplar retrieval component may select an exemplar including the example user input of “please turn on the lights” and the API call of “turn_on_device (device=“lights”).” In some embodiments, an exemplar represented in the exemplar data 794 may include an example user input, a natural language description of an action associated with the example user input, an executable API call associated with the example user input and the action associated with the example user input, an example result of the API call, a natural language description of an action to be performed in response to the example result of the API call, and/or an output responsive to the user input. For example, for an API associated with the API call frameworks “Routine.create_turn_on_action (device: str)” and “Routine.create_time_trigger (hour: [hour value])” and the current user input “please turn on the kitchen light everyday at 7 am,” the exemplar retrieval component may select an exemplar representing:

{
Customer: turn on the kitchen light everyday at 7am
Thought: the customer is trying to create a routine
Action:
Routine.create_routine(trigger=Routine.create_time_trigger(hour=
7), action=Routine.create_turn_on_action(device=“kitchen light”))
Observation: routine created successfully
Thought: time to respond
Response: I have created a routine for you. Anything else?
}

Although not illustrated in FIG. 7, in some embodiments, the API provider component 790 and/or a knowledge provider component may provide the exemplar retrieval component with the action data 785 and a list of API call(s) to which the determined exemplars are to be associated (e.g., the API call(s) included in the API data 792). In some embodiments, the one or more exemplars may be included in the exemplar data 794 based on them being semantically similar to the user input. For example, the exemplar retrieval component may be capable of comparing (e.g., using cosine similarity) the current user input to the example user input included in an exemplar to determine a semantic similarity between the current user input and the example user input. If the example user input is determined to be semantically similar to the current user input, then the corresponding exemplar may be included in the exemplar data 794. In some embodiments, the exemplar retrieval component may include the top-n identified exemplars in the exemplar data 794. The exemplar data 794 may be sent (at step 4) to the action plan execution component 780 as shown in FIG. 7.

As another example, a device state retrieval component (not shown in FIG. 7) may process the action data 785 to generate device state data 796 representing one or more states of one or more devices associated with/relevant to the user input (e.g., whether the device is powered on or off, a volume level associated with the device, etc.). For example, if the user input corresponds to “Please turn on the kitchen light,” the device state data 796 may represent the state(s) of one or more devices that are associated with a functionality of turning on a light, are associated with the kitchen, are associated with a user profile of a user who provided the user input, etc. In some embodiments, the device(s) may be determined to be relevant based on a device location(s). For example, devices (e.g., microwave, oven, fridge, smart speaker, etc.) near the user device (e.g., located in the kitchen) that received the user input may be used to determine the device state data 796. In some embodiments, the one or more devices may be determined to be relevant to the user input based on device profile information. For example, the device state retrieval component may be capable of comparing device profile information for a device (e.g., device ID, device group ID, a location associated with the device, etc.) to the user input to determine whether the device is relevant to the user input. In some embodiments, the device state retrieval component may include the top-n identified device states in the device state data 796. The device state data 796 may be sent (at step 4) to the action plan execution component 780 as shown in FIG. 7.

As a further example, a context retrieval component (not shown) may process the action data 785 to generate other context data 48 (apart from the device state data 796, the API data 792, the exemplar data 794, etc.) representing one or more contexts associated with/relevant to the user input. For example, the other context data 48 may represent user profile information (age, gender, associated devices, user preferences, etc.), visual context (e.g., content being displayed by devices associated with the user profile, content being displayed by the user device that captured the user input, etc.), knowledge context (e.g., one or more previous user inputs and/or system generated responses, etc.), time of day, geographic/device location, weather information, etc. In some embodiments, the other context retrieval component 48 may include the top-n identified context in the other context data 48. The other context data 48 may be sent (at step 4) to the action plan execution component 780 as shown in FIG. 7.

In some embodiments, the knowledge provider component may be configured to cause one or more of the API retrieval components, the exemplar retrieval component, the device state retrieval component, and the other context retrieval component to process based on the data output by one or more of the components of the knowledge provider component. For example, if the output of the API retrieval component (e.g., the API data 792) indicates that a related API definition was identified, then the knowledge provider component (or another component) may cause the exemplar retrieval component to process to determine one or more exemplars related to the identified API definitions. For further example, if the output of the API retrieval component (e.g., the API data 792) indicates that a particular API definition was identified (e.g., an API definition for controlling a device), then the knowledge provider component may cause the exemplar retrieval component to process as described above, and may further cause the device state retrieval component and/or the other context retrieval component to process to determine device states for one or more related devices and/or other contextual information based on the identified API definition being associated with controlling a device. In some embodiments, the knowledge provider component may determine to cause the components to process based on instruction(s) included in the action data (e.g., based on a determination made by preliminary action plan generation component 740, as discussed above).

The action plan execution component 780 may send (step 5) the data received from the API provider component 790 (e.g., the API data 792, the exemplar data 794, the device state data 796, and the other context data 48) to the LLM prompt generation component 750. The LLM prompt generation component 750 may be configured to generate prompt data 755 (e.g., using the user input data 727, the API data 792, the exemplar data 794, the device state data 796, and/or the other context data 48) to be used by the LLM 760.

In some examples, the LLM prompt generation component 750 may generate the prompt data 755 representing a prompt for input to the LLM 760. In some embodiments, such prompt data 755 may be generated based on combining the user input data 727, the API data 792, the exemplar data 794, the device state data 796, and the other context data 48. The prompt data 755 may be an instruction to determine an action(s) responsive to the user input data 727 given the other information (e.g., the API data 792, the exemplar data 794, the device state data 796, the other context data 48) included in the prompt data 755. In some embodiments, the LLM prompt generation component 750 may also include in the prompt data 755 a sample processing format to be used by the LLM 760 when processing the prompt and generating the response. In some embodiments, the prompt data 755 may be generated according to a template format. For example, the prompt data 755 may adhere to a template format of:

{
You have access to the following API's:
[API(s) (e.g., the API data 192)]
Use the following format:
User: the input utterance of a user
Thought: optionally think about what to do
Action: take an action by calling APIs
Observation: what the API execution returns
... (this thought/action/action input/observation can repeat N times)
Thought: done
Response: the proper response to the user (end of turn)
Examples:
[Exemplar(s) (e.g., the exemplar data 794)]
Context: [device state(s) (e.g., the device state data 796)] [other
context(s) (e.g., the other context data 48)]
User: [the user input (e.g., the user input data 727)]
}

In some examples, the template format may instruct the LLM 760 as to how it should process to determine the action responsive to the user input and/or how it should generate the output including the action response to the user input. For example, as shown in the example above, the format may include the label “User:” labelling the following string of characters/tokens as the user input. For further example, the format may include the label “Thought:” instructing the LLM 760 to generate an output representing the determined interpretation of the user input by the LLM 760 (e.g., the user is requesting [intent of the user input], the user is trying to [intent of the user Input], etc.) As another example, the format may include the label “Observation:” labeling the following string of characters/tokens as the result of performance of an action determined by the LLM 760/the LLM 760's interpretation of the result of the performance of the action determined by the LLM 760. As a further example, the format may include a label of “Response:” instructing the LLM 760 to generate a response (e.g., a natural language output for a user) to the prompt.

Following such a template format, for example, and for a user input of “turn on the living room light” and corresponding API data, exemplar data, device state data, and other context data, the LLM prompt generation component 750 may generate example prompt data 755a:

{
You have access to the following API's:
Routine.turn_on_device (device: [device name]) turns a device on.
Use the following format:
User: the input utterance of a user
Thought: optionally think about what to do
Action: take an action by calling APIs
Observation: what the API execution returns
... (this thought/action/action input/observation can repeat N times)
Thought: done
Response: the proper response to the user (end of turn)
Examples:
User: turn on all indoor lights
Thought: the user is trying to turn lights on
Action: turn_on_device (device=“indoor light 1”)
turn_on_device (device=“indoor light 2”)
Observation: success success
Thought: time to respond
Response: Anything else I can help you with?
Context: the user has the following devices, bathroom light,
bedroom light, kitchen light, and living room light.
User: turn on the living room light.
}

In some embodiments, the LLM prompt generation component 750 may also include in the prompt data an instruction to output a response that satisfies certain conditions. Such conditions may relate to generating a response that is unbiased (toward protected classes, such as gender, race, age, etc.), non-harmful, profanity-free, etc. For example, the prompt data may include “Please generate a polite, respectful, and safe response and one that does not violate protected class policy.”

The LLM 760 processes the prompt data 755 to generate model output data 765 representing an action responsive to the user input. For example, based on processing the example prompt data provided above, the LLM 760 may output model output data 765: {“Thought: the user is trying to turn on the living room light; Action: turn_on_device (device=“living room light”),”} or the like. The model output data 765 is sent (at step 7) to the action plan generation component 770. The action plan generation component 770 may parse the model output data 765 to determine action plan data representing the action generated by the LLM 760. For example, for the model output data 765: “Action: turn_on_device (device=“living room light”),” the corresponding action plan data may correspond to “turn_on_device (device=” living room light “)” (e.g., corresponding to the action generated by the LLM 760, without the label of “Action”). In some embodiments, the action plan generation component 770 may determine an API call corresponding to the “Action” data included in the model output data 765. For example, in some embodiments, the action plan generation component 770 may fill in the arguments/inputs, if any, for the API call, which may be included in the action plan data. For further example, in some embodiments, the action plan execution component 770 may fill in the arguments/inputs, if any, for the API call.

In some embodiments, the LLM orchestrator 730 (e.g., the action plan generation component 770 or another component of the LLM orchestrator 730) may determine whether the LLM 760 output satisfies certain conditions. Such conditions may relate to checking whether the output includes biased information (e.g., bias towards a protected class), harmful information (e.g., violence-related content, harmful content), profanity, content based on model hallucinations, etc. A model hallucination refers to when a model (e.g., a language model) generates a confident response that is not grounded in any of its training data. For example, the model may generate a response including a random number, which is not an accurate response to an input prompt, and then the model may continue to falsely represent that the random number is an accurate response to future input prompts. To check for an output being based on model hallucinations, the LLM orchestrator 730 may use a knowledge base, web search, etc. to fact-check information included in the output.

Although various systems described herein may be embodied in software or code executed by general purpose hardware as discussed above, as an alternate the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those of ordinary skill in the art and consequently, are not described in detail herein.

The flowcharts and methods described herein show the functionality and operation of various implementations. If embodied in software, each block or step may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processing component in a computer system. If embodied in hardware, each block may represent a circuit or a number of interconnected circuits to implement the specified logical function(s).

Although the flowcharts and methods described herein may describe a specific order of execution, it is understood that the order of execution may differ from that which is described. For example, the order of execution of two or more blocks or steps may be scrambled relative to the order described. Also, two or more blocks or steps may be executed concurrently or with partial concurrence. Further, in some embodiments, one or more of the blocks or steps may be skipped or omitted. It is understood that all such variations are within the scope of the present disclosure.

Also, any logic or application described herein that comprises software or code can be embodied in any non-transitory computer-readable medium or memory for use by or in connection with an instruction execution system such as a processing component in a computer system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as magnetic, optical, or semiconductor media. More specific examples of a suitable computer-readable media include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described example(s) without departing substantially from the spirit and principles of the disclosure. All such modifications and variations are intended to be included herein within the scope of this disclosure and protected by the following claims.

What is claimed is:

1. A computer-implemented method comprising:
receiving a first audio signal comprising first speech, wherein the first speech includes a first request to control a first device;
generating, using an acoustic encoder, first embedding data representing the first audio signal;
generating, using a text encoder, second embedding data representing a first entity, wherein the first entity corresponds to the first device;
generating a first modified embedding using a first multi-head attention mechanism, wherein the first multi-head attention mechanism uses first query data generated from the first embedding data and first key data and first value data generated from the second embedding data;
generating a second modified embedding using a second multi-head attention mechanism, wherein the second multi-head attention mechanism uses second query data generated from the second embedding data and second key data and second value data generated from the first embedding data;
generating first multi-modal embedding data using the first modified embedding and the second modified embedding;
generating, by inputting the first multi-modal embedding data into at least one linear layer, first score data indicating a correspondence between the first audio signal and the first entity;
determining that the first speech mentions the first device based on the first score data; and
executing a first action to control the first device in response to the first request.

2. The computer-implemented method of claim 1, further comprising:
training an encoder model to generate the first multi-modal embedding data using a cross-modality alignment loss, wherein the cross-modality alignment loss trains the encoder model to identify multi-modal embeddings that represent audio mentioning a second entity and ground truth entity data for the second entity.

3. The computer-implemented method of claim 1, further comprising:
training an encoder model to generate the first multi-modal embedding data using a discriminative loss, wherein the discriminative loss trains the encoder model to generate similar multi-modal embedding data for different input audio samples that refer to the same entity and different multi-modal embedding data for different input audio samples that refer to different entities.

4. A method comprising:
receiving first audio data representing speech comprising a natural language request that mentions a first entity;
generating first embedding data representing the first audio data;
determining second embedding data representing the first entity;
generating a first modified embedding using a first attention mechanism to compare the first embedding data to the second embedding data;
determining, based at least in part on the first modified embedding, that the first audio data comprises the mention of the first entity; and
performing a first action with respect to the first entity in response to the natural language request.

5. The method of claim 4, further comprising:
generating, by the first attention mechanism, first query data generated from the first embedding data; and
generating, by the first attention mechanism, first key data and first value data generated from the second embedding data, wherein the first modified embedding is generated based at least in part on the first query data, the first key data, and the first value data.

6. The method of claim 5, further comprising:
generating a second modified embedding using a second attention mechanism to compare the first embedding data to the second embedding data;
generating a fused embedding by combining the first modified embedding and the second modified embedding; and
determining that the first audio data comprises the mention of the first entity based at least in part on the fused embedding.

7. The method of claim 6, further comprising:
generating, by the second attention mechanism, second query data generated from the second embedding data; and
generating, by the second attention mechanism, second key data and second value data generated from the first embedding data, wherein the fused embedding is generated based at least in part on the second query data, the second key data, and the second value data.

8. The method of claim 4, further comprising:
generating, for each entity of a plurality of entities, a respective entity embedding;
determining, using the first attention mechanism, at least one attention score for each entity embedding; and
selecting a first entity embedding corresponding to the first entity based at least in part on the attention score for the first entity embedding.

9. The method of claim 4, further comprising:
training an encoder model to generate the first modified embedding using a cross-modality alignment loss, wherein the cross-modality alignment loss trains the encoder model to identify multi-modal embeddings that represent audio mentioning a second entity and ground truth entity data for the second entity.

10. The method of claim 4, further comprising:
training an encoder model to generate the first modified embedding using a discriminative loss, wherein the discriminative loss trains the encoder model to generate similar multi-modal embedding data for different input audio samples that refer to the same entity and different multi-modal embedding data for different input audio samples that refer to different entities.

11. The method of claim 4, further comprising:
sending first entity data representing that the first audio data comprises the mention of the first entity to a large language model (LLM); and
sending a first transcription of the speech to the LLM.

12. The method of claim 4, further comprising:
generating first entity data representing the determination that the first audio data comprises the mention of the first entity;
determining second entity data representing a determination that a transcription of the first audio data generated by a first automatic speech recognition (ASR) model comprises a second entity different from the first entity; and
updating the ASR model based at least in part on a difference between the first entity and the second entity.

13. A system comprising:
at least one processor; and
non-transitory computer-readable memory storing instructions that, when executed by the at least one processor, are effective to:
receive first audio data representing speech comprising a natural language request that mentions a first entity;
generate first embedding data representing the first audio data;
determine second embedding data representing the first entity;
generate a first modified embedding using a first attention mechanism to compare the first embedding data to the second embedding data;
determine, based at least in part on the first modified embedding, that the first audio data comprises a mention of the first entity; and
perform a first action with respect to the first entity in response to the natural language request.

14. The system of claim 13, the non-transitory computer-readable memory storing further instructions that, when executed by the at least one processor, are further effective to:
generate, by the first attention mechanism, first query data generated from the first embedding data; and
generate, by the first attention mechanism, first key data and first value data generated from the second embedding data, wherein the first modified embedding is generated based at least in part on the first query data, the first key data, and the first value data.

15. The system of claim 14, the non-transitory computer-readable memory storing further instructions that, when executed by the at least one processor, are further effective to:
generate a second modified embedding using a second attention mechanism to compare the first embedding data to the second embedding data;
generate a fused embedding by combining the first modified embedding and the second modified embedding; and
determine that the first audio data comprises the mention of the first entity based at least in part on the fused embedding.

16. The system of claim 15, the non-transitory computer-readable memory storing further instructions that, when executed by the at least one processor, are further effective to:
generate, by the second attention mechanism, second query data generated from the second embedding data; and
generate, by the second attention mechanism, second key data and second value data generated from the first embedding data, wherein the fused embedding is generated based at least in part on the second query data, the second key data, and the second value data.

17. The system of claim 13, the non-transitory computer-readable memory storing further instructions that, when executed by the at least one processor, are further effective to:
generate, for each entity of a plurality of entities, a respective entity embedding;
determine, using the first attention mechanism, at least one attention score for each entity embedding; and
select a first entity embedding corresponding to the first entity based at least in part on the attention score for the first entity embedding.

18. The system of claim 13, the non-transitory computer-readable memory storing further instructions that, when executed by the at least one processor, are further effective to:
train an encoder model to generate the first modified embedding using a cross-modality alignment loss, wherein the cross-modality alignment loss trains the encoder model to identify multi-modal embeddings that represent audio mentioning a second entity and ground truth entity data for the second entity.

19. The system of claim 13, the non-transitory computer-readable memory storing further instructions that, when executed by the at least one processor, are further effective to:
training an encoder model to generate the first modified embedding using a discriminative loss, wherein the discriminative loss trains the encoder model to generate similar multi-modal embedding data for different input audio samples that refer to the same entity and different multi-modal embedding data for different input audio samples that refer to different entities.

20. The system of claim 13, the non-transitory computer-readable memory storing further instructions that, when executed by the at least one processor, are further effective to:
send first entity data representing that the first audio data comprises a mention of the first entity to a large language model (LLM); and
send a first transcription of the speech to the LLM.
